(19) United States
(12) Patent Application Publication
(10) Pub. No.: US 2006/0217958 A1
(43) Pub. Date: Sep. 28, 2006

(54) Electronic device and recording medium

(75) Inventors: Masatoshi Tagawa, Ebina-shi (JP); Kiyoshi Tashiro, Kawasaki-shi (JP); Michihiro Tamune, Ashigarakami-gun (JP); Hiroshi Masuichi, Ashigarakami-gun (JP); Kyosuke Ishikawa, Minato-ku (JP); Atsushi Itoh, Ashigarakami-gun (JP); Naoko Sato, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/218,512

(22) Filed: Sep. 6, 2005

(30) Foreign Application Priority Data
Mar. 25, 2005 (JP) 2005-090199

(51) Int. Cl. G06F 17/28

(52) U.S. Cl. 704/2

(57) ABSTRACT

The invention provides an electronic device that has an identification unit that performs character recognition processing on image data representing a text written in a first language and identifies candidate character strings representing results of the character recognition processing for each of structural units of the text, a decision unit that decides whether a second language selected by a user is different from the first language, a presentation unit that presents translations of the candidate character strings in the second language for each of structural units for which plural candidate character strings are identified when the first language and the second language are different, and a selection unit that allows the user to select a single translation from the translations presented by the presentation unit.

### BACKGROUND OF THE INVENTION

1. Field of the Invention

The present invention relates to a technology for performing OCR (Optical Character Reader) processing of paper documents, whose text is written in a first language, for the purpose of acquiring the text, and, in particular, to a technology permitting efficient correction of recognition errors resulting from the OCR processing.

2. Description of the Related Art

In recent years, following the spread of the Internet and other world-wide communication environments and the growing internationalization in the world of business and various other fields, there has been an increase in the likelihood of encountering texts written in languages other than one's regularly used language, such as a mother tongue, etc. For this reason, the demand for simple and easy text translation is on the increase and various technologies have been proposed to meet this demand. As an example of such a technology, translation software is installed on a computer apparatus, such as a personal computer (called a “PC” below), in order to provide machine translation, during which translation processing is executed by the translation software.

Incidentally, for a computer apparatus to execute machine translation of an original text recorded in a paper document, it is necessary to input data representing the original text into the computer apparatus, for example, by performing OCR processing on the paper document. However, since the character recognition rate of OCR processing is not 100%, multiple candidate character strings may sometimes be obtained for a single character. When such multiple candidate character strings are obtained, it is necessary to allow the user to select a single candidate character string correctly representing the character written in the original text from among the multiple candidate character strings so as to correct the processing results obtained by OCR processing. However, if they occur frequently, such corrections cause a sharp decline in the efficiency of OCR processing.

### SUMMARY OF THE INVENTION

In order to address the above problems, the present invention provides, in one aspect, an electronic device having: an input unit that inputs image data representing a text written in a first language, an identification unit that performs character recognition processing on the image data inputted by the input unit and identifies candidate character strings representing results of the character recognition processing for each of structural units of the text represented by the image data, a specification unit that allows a user to specify a second language, a decision unit that decides whether or not the second language is different from the first language, a presentation unit that presents translations of the candidate character strings in the second language for each of structural units for which plural candidate character strings are identified by the identification unit, when the decision unit decides that the first language and the second language are different, and a selection unit that allows the user to select a single translation from the translations presented by the presentation unit.

According to an embodiment of the invention, even if the language used to write the original text is different from the user language, a user can efficiently correct character recognition results produced by OCR processing when OCR processing is performed on an original text recorded in a paper document in order to acquire the original text.

### BRIEF DESCRIPTION OF THE DRAWINGS

Embodiments of the present invention will be described in detail based on the following figures, wherein:

FIG. 1 is a block diagram illustrating an exemplary configuration of a translation system 10, which is equipped with a translation apparatus 110 representing an electronic device according to an embodiment of the invention;

FIG. 2 is a block diagram illustrating an example of hardware configuration of the translation apparatus 110;

FIG. 3 is a diagram illustrating an example of the language specification screen displayed on the display unit 220;

FIG. 4 is a flow chart illustrating the flow of translation processing performed by the control unit 200 using the translation software;

FIGS. 5(a), 5(b) and 5(c) are diagrams illustrating an example of contents displayed on the display unit 220 of the translation apparatus 110 during translation processing;

FIG. 6 is a diagram illustrating an example of candidate character strings displayed in Modification Example 3; and

FIG. 7 is a diagram illustrating an example of candidate character strings presented in Modification Example 5.

### DETAILED DESCRIPTION OF THE INVENTION

Hereinafter, embodiments of the present invention will be described with reference to the accompanying drawings.

### A. CONFIGURATION

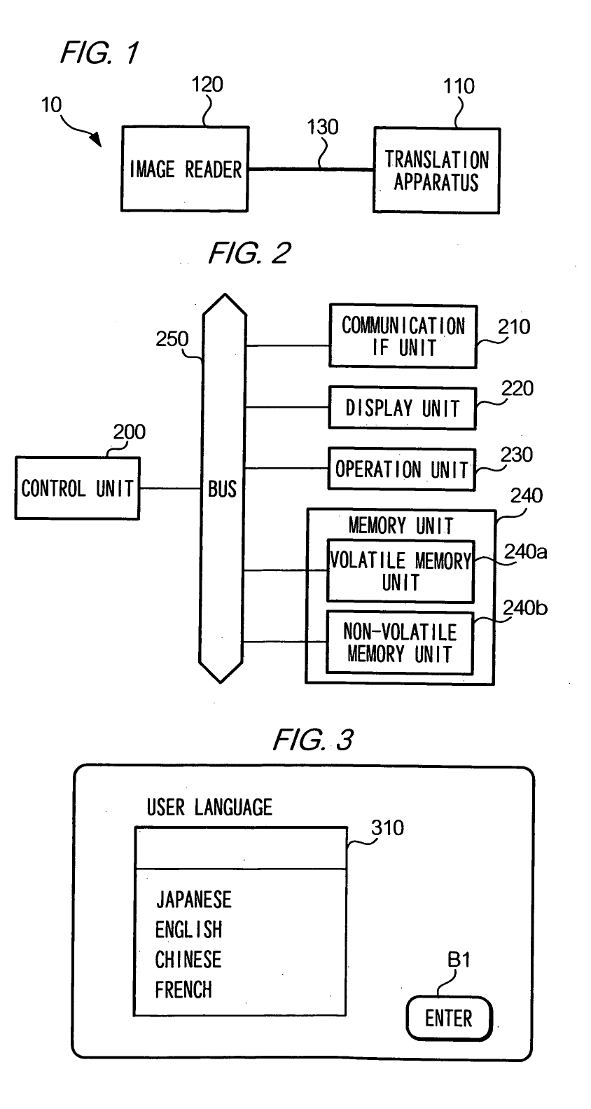

FIG. 1 is a block diagram illustrating an exemplary configuration of a translation system 10, which is provided with a translation apparatus 110 and represents an electronic device according to an embodiment of the invention. As shown in FIG. 1, an image reader 120, which is a scanner apparatus provided with an automatic paper feeding mechanism such as an ADF (Auto Document Feeder), optically acquires a paper document placed in the ADF one page at a time and transmits image data corresponding to the acquired images to the translation apparatus 110 via a communication line 130, such as a LAN (Local Area Network), etc. In addition, while the present embodiment illustrates a case, in which the communication line 130 is a LAN, as a matter of course, it may also be a WAN (Wide Area Network), or the Internet. In addition, while the present embodiment illustrates a case, in which the translation apparatus 110 and image reader 120 are constituted as respective individual pieces of hardware, it goes without saying that the two may be constituted as a single integrated piece of hardware. In such an embodiment, the communication line 130 is an internal bus connecting the translation apparatus 110 to the image reader 120 in the hardware.

The translation apparatus 110 of FIG. 1 is equipped with functions for translating text represented by image data transmitted from the image reader 120 to a translation destination language different from the translation source language used to write the text and for displaying the results of the translation (namely, a translation of the text into the translation destination language). In addition, the present embodiment illustrates a case, in which the translation source language is Chinese, and the translation destination language is English. In addition, in the present embodiment, image data transmitted from the image reader 120 to the translation apparatus 110 represent a text to be translated (in other words, the original text), and will be hereinafter called “original text data”.

FIG. 2 is a diagram illustrating an example of hardware configuration of the translation apparatus 110.

As shown in FIG. 2, the translation apparatus 110 is equipped with a control unit 200, a communication interface (hereafter, IF) unit 210, a display unit 220, an operation unit 230, a memory unit 240, and a bus 250 mediating data interchange between these constituent elements.

The control unit 200, which is, e.g. a CPU (Central Processing Unit), effects central control over each unit in the translation apparatus 110 by running various software stored in the memory unit 240, which will be described below. The communication IF unit 210, which is connected to the image reader 120 via the communication line 130, receives original text data sent via the communication line 130 from the image reader 120 and passes it on to the control unit 200. In short, the communication IF unit 210 functions as an input unit for inputting the original text data sent from the image reader 120.

The display unit 220, which is, e.g. a liquid crystal display and its driving circuitry, displays images corresponding to the data transmitted from the control unit 200 and offers various user interfaces. The operation unit 230, which is, e.g. a keyboard equipped with multiple keys (drawing omitted), transmits user operation contents to the control unit 200 by transmitting data (hereafter, operation contents data) corresponding to the key operation contents.

As shown in FIG. 2, the memory unit 240 contains a volatile memory unit 240a and a non-volatile memory unit 240b. The volatile memory unit 240a, which is, e.g. a RAM (Random Access Memory), is used as a work area by the control unit 200 running various software described below. On the other hand, the non-volatile memory unit 240b is, e.g. a hard disk. Stored in the non-volatile memory unit 240b are data and software allowing the control unit 200 to implement functions peculiar to the translation apparatus 110 of the present embodiment.

Various bilingual dictionaries used in the execution of the above machine translation are suggested as examples of the data stored in the non-volatile memory unit 240b. On the other hand, translation software and OS software, which allows the control unit 200 to implement an operating system (Operating System, hereinafter called “OS”), are suggested as examples of software stored in the non-volatile memory unit 240b. Here, the term “translation software” refers to software allowing the control unit 200 to perform processing, whereby an original text represented by original text data inputted through the image reader 120 is translated into a predetermined translation destination language. Below, explanations are provided regarding the functionality imparted to the control unit 200 as a result of executing the software programs.

When the power supply (drawing omitted) of the translation apparatus 110 is turned on, first of all, the control unit 200 reads the OS software from the non-volatile memory unit 240b and executes it. As it executes the OS software and thereby brings an OS into being, the control unit 200 is imparted with functionality for controlling the units of the translation apparatus 110 and functionality for reading other software from the non-volatile memory unit 240b and executing it in accordance with the user's instructions. For example, when an instruction is issued to run the translation software, the control unit 200 reads the translation software from the non-volatile memory unit 240b and executes it. When executing the translation software, the control unit 200 is imparted with, at least, seven functions described below.

First of all, a function that allows a user to specify the regularly used language (i.e., the user language) and to store the specified contents. Speaking specifically, first of all, the control unit 200 uses the display unit 220 to display a language specification screen, such as the one shown in FIG. 3. A user who has visually examined the language specification screen can then specify their own language by appropriately operating a pull-down menu 310 via the operation unit 230 and then enter the desired user language by pressing an ENTER button, B1. On the other hand, the control unit 200 identifies the user language based on the operation contents data transmitted from the operation unit 230 and then writes and stores data (hereinafter, user language data) representing the user language in the volatile memory unit 240a. Besides, although the present embodiment illustrates a case, in which the user language is specified via the pull-down menu, the user may be allowed to specify a user-specified language by keying in character string data etc. representing the user language.

Second, it has a function allowing it to perform character recognition processing, for instance OCR processing, on original text data inputted from the image reader 120, and to identify candidate character strings representing recognition results for each word making up the original text represented by original data.

Third, it has a decision function for deciding whether or not the translation source language used to write the original text represented by the original data is different from the user language specified by the user. Since “Chinese” is preset as the translation source language in the present embodiment, the control unit 200 decides whether or not the user language specified by the user is Chinese, and if it is not Chinese, it makes the decision that the translation source language and the user language are different.

Fourth, it has a function for presenting user language translations for words having multiple candidate character strings identified by the second function when the third function decides that the user language and the translation source language are different. Speaking more specifically, the control unit 200 decides whether or not multiple candidate character strings have been identified by the second function for any of the words making up the original text represented by the original data, user language translations of words represented by each of the multiple candidate character strings are identified by referring to the bilingual dictionary for words having positive decision results (i.e., words having multiple identified candidate character strings), and the character strings representing the translations are displayed on the display unit 220 so as to present the translations.

Fifth, it has a function for allowing the user to select a single translation from among multiple translations presented by the fourth function and to store the selection results in memory.

Sixth, in case of structural units having a candidate character string is uniquely identified by the second function, the corresponding candidate character string is used, and in case of structural units having multiple identified candidate character strings, code data is generated that represents text composed using candidate character strings corresponding to the translations stored by the fifth function. Here, the code data is data, wherein the character codes (for instance, ASCII codes and Shift-JIS codes, etc.) of the characters making up the text are arranged in the order, in which the characters are written. Although the present embodiment illustrates a case, in which code data is generated that represents text composed using the corresponding candidate character strings in case of structural units having candidate character strings uniquely identified by the second function and using candidate character strings corresponding to the translations stored by the fifth function in case of structural units having multiple identified candidate character strings, it is, of course, also possible to generate image data representing the text.

And, seventh, it has a function for translating text represented by the code data generated by the sixth function into a translation in the translation destination language and for displaying the translation results on the display unit 220. In addition, although the present embodiment illustrates a case, in which the results of translation of the text represented by the code data into the translation destination language are displayed on the display unit 220, it is also possible to generate image data and code data representing such translation results, transmit them to an image forming apparatus such as a printer, and print the translation results, as well as to store the image data and code data representing the translation results in association with the original text data.

As explained above, the hardware configuration of such a translation apparatus 110 according to the present embodiment is identical to the hardware configuration of an ordinary computer apparatus, with the functionality peculiar to the inventive electronic device implemented by enabling the control unit 200 to execute various software stored in the non-volatile memory unit 240b. Thus, although the present embodiment illustrates a case, in which the functionality peculiar to the inventive electronic device is implemented with the help of a software module, the inventive electronic device may be constituted by combining hardware modules that perform these functions.

### B: OPERATION

Next, explanations are provided regarding the operation of the translation apparatus 110, with emphasis on operations that will illustrate its remarkable features. In addition, in the operation example explained below, the user operating the translation apparatus 110 is presumed to be a Japanese person who is not skilled in any language except his or her own mother tongue (i.e., Japanese). Moreover, below, it is assumed that the control unit 200 of the translation apparatus 110 runs the OS software and waits for the user to perform input operations.

If the user properly operates the operation unit 230 and performs an input operation that issues an instruction to execute the translation software, the operation unit 230 transmits operation contents data corresponding to the contents of the operation to the control unit 200. In the present operation example, the operation contents data used to issue the instruction to execute the translation software is transmitted from the operation unit 230 to the control unit 200, with the control unit 200 reading the translation software from the non-volatile memory unit 240b and executing it in accordance with the operation contents data. The translation operation of the control unit 200 running the translation software is explained hereinbelow by referring to drawings.

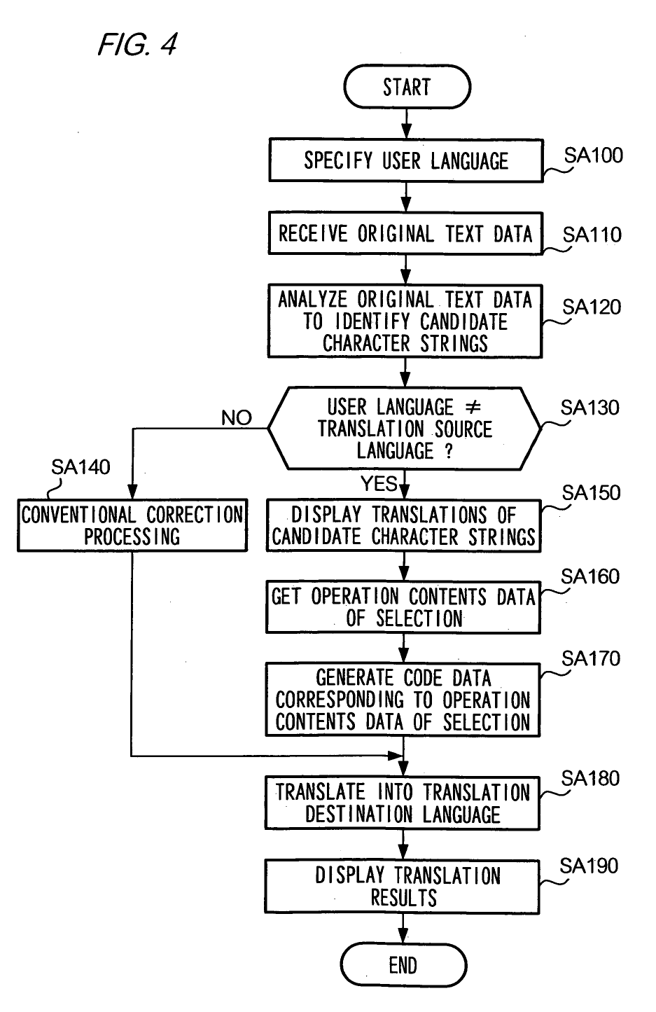

FIG. 4 is a flow chart illustrating the flow of translation processing performed by the control unit 200 using the translation software. First of all, as shown in FIG. 4, the control unit 200 displays a language specification screen (see FIG. 3) on the display unit 220 and allows the user to specify a user language (step SA100). As described above, a user who has visually inspected the language specification screen can then specify the desired user language by appropriately operating the pull-down menu 310 and then pressing the ENTER button B1. The control unit 200 receives operation contents data representing user operation contents (i.e., data representing the items selected from the pull-down menu and data reflecting the fact that the ENTER button B1 has been pressed) from the operation unit 230 and identifies the language that has been selected based on the operation contents data (i.e., the number of the item in the pull-down menu, in which the selected language is displayed). In addition, since the user who operates the translation apparatus 110 is not skilled in any languages other than “Japanese”, “Japanese” is selected as the user language in this operation example.

Next, the control unit 200 writes user language data representing the language identified by the operation contents data transmitted from the operation unit 230 to the volatile memory unit 240a, storing it there, and waits for original text data to be sent from the image reader 120. On the other hand, when the user places a paper document in the ADF of the image reader 120 and performs certain specified operations (for instance, pressing the START button provided on the operation unit of the image reader 120 etc.), an image representing contents recorded in the paper document is acquired by the image reader 120 and original text data corresponding to the image is sent via the communication line 130 from the image reader 120 to the translation apparatus 110. Additionally, in the present embodiment, image data representing text written in “Chinese” is sent as original text data from the image reader 120 to the translation apparatus 110.

Now, when the control unit 200 receives the original text data sent from the image reader 120 via the communication IF unit 210 (step SA110), it carries out OCR processing on the original text data so as to effect character recognition and identifies candidate character strings representing recognition candidates for each word making up the original text represented by the original text data (step SA120). Then, the control unit 200 decides whether or not the user language specified by the user via the language specification screen and the translation source language are different (step SA130), and, when it is decided that the two are identical, it carries out conventional correction processing (step SA140), and, on the other hand, it executes correction processing (namely, in FIG. 4: processing from step SA150 to step SA170), which is characteristic of the electronic device according to the embodiment of the invention, when it is decided that they are different.

As used here, the term “conventional correction processing” designates processing that contains steps of displaying candidate character strings for a word with multiple candidate character strings identified in step SA120 on the display unit 220, allowing the user to select a single candidate character string that correctly represents the word in the original text represented by the original data, and generating code data representing the original text in response to the selection results. Thus, if multiple candidate character strings in the translation source language are displayed on the display unit 220 when the user language and the translation source language are the same, the user can select a single candidate character string correctly representing the word in the original text from among the multiple candidate character strings.

Conversely, if these candidate character strings are displayed “as is” when the user language and the translation source language are different, the user cannot select a single candidate character string correctly representing the word in the original text. Thus, in such a case, the translation apparatus 110 performs the correction processing peculiar to the electronic device according to the embodiment of the invention, which allows the user to select a single candidate character string correctly representing the word in the original text from among the multiple candidate character strings. Since the user language specified in step SA100 is “Japanese” and the translation source language is “Chinese”, in this operation example the decision result in step SA130 is “Yes” and processing from step SA150 to step SA170 is executed.

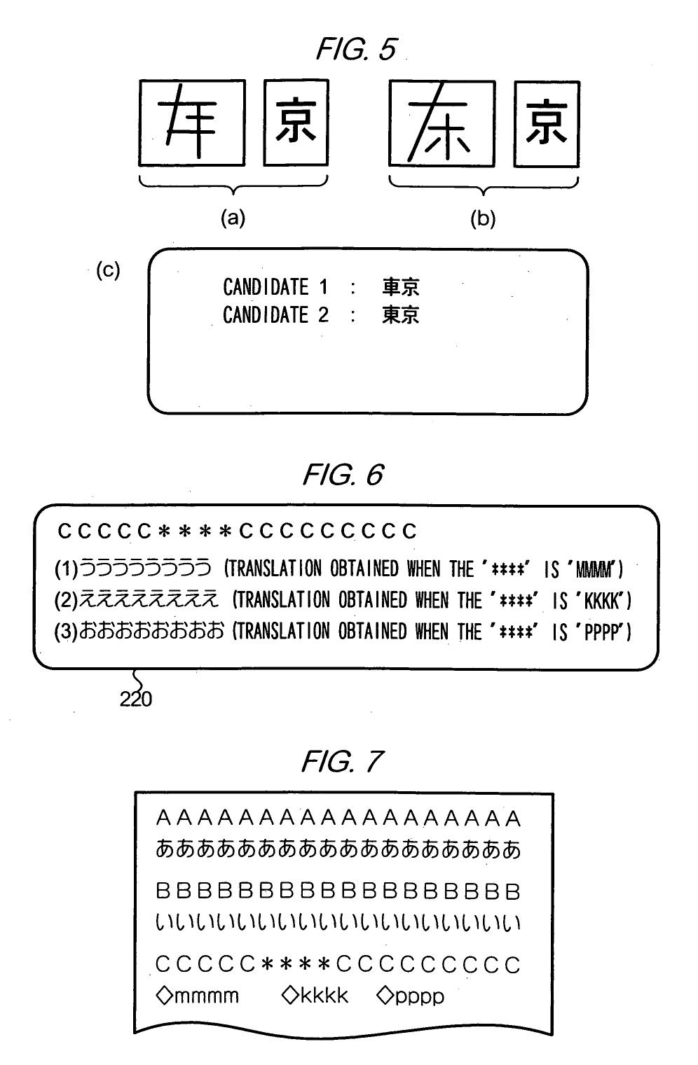

When the decision result in step SA130 is “Yes”, then in the subsequently executed step SA150 the control unit 200 translates words represented by the candidate character strings into words in the user language in case of the words having multiple identified candidate character strings among the words that make up the text represented by the original text data and displays the translations on the display unit 220. For instance, as shown in FIGS. 5(a) and 5(b), when two candidate character strings are identified for a single word contained in the original text represented by the original data, the control unit 200 uses the display unit 220 to display a selection screen (see FIG. 5(c)) that presents user language translations of the two candidate character strings to the user. The user who has visually inspected the selection screen can then select a single candidate character string from the two candidate character strings by appropriately operating the operation unit 230 and referring to the translations presented on the selection screen. In this operation example, it is assumed that the user selects [symbol] from the translations presented on the selection screen illustrated in FIG. 5(c).

After carrying out the above selection, the control unit 200 receives operation contents data representing the contents of the selection from the operation unit 230 (step SA160), deletes candidate character strings other than the candidate character string represented by the operation contents data from the processing results obtained by character recognition processing in step SA120, and generates code data representing the text to be translated (step SA170). Speaking more specifically, in step SA170, code data is generated that represents text composed using corresponding candidate character strings in case of words having candidate character strings uniquely identified in step SA120 and using candidate character 25 strings corresponding to the translations selected in step SA160 in case of words having multiple identified candidate character strings.

The above represents the correction processing peculiar to the electronic device according to the embodiment of the invention.

By referring to the bilingual dictionary stored in the non-volatile memory unit 240b, the control unit 200 then translates the text represented by the code data generated in step SA140 or step SA170 into the translation destination language (step SA180) and transmits image data representing the translation to the display unit 220, where the translation is displayed (step SA190). In the present embodiment, the translation destination language is “English”, and therefore the word, for which the translation [symbol] has been selected on the selection screen (see FIG. 5(c)), is translated as “Tokyo”.

As explained above, even if the translation source language is different from the user language of the user who uses the translation apparatus, the translation apparatus of the present embodiment achieves the effect of enabling the user to efficiently correct character recognition results produced by OCR processing and perform translation into the translation destination language when an original text recorded in a paper document in a certain translation source language is acquired via OCR processing and the original text is translated into a predetermined translation destination language.

### C. MODIFICATION EXAMPLES

The above-described embodiment is one exemplary embodiment of the invention, and as a matter of course, it may be modified, for example, as follows.

### C-1: Modification Example 1

The above-described embodiment illustrated a case, in which the present invention was applied to a translation apparatus receiving original text data obtained by optically acquiring a paper document and performing machine translation on the text represented by the original text data. The invention, however, can be also applied to an electronic device receiving the original text data, performing OCR processing on the original text data, and storing the obtained data in memory or transferring it to other equipment.

### C-2: Modification Example 2

The above-described embodiment illustrated a case, in which a text written in a translation source language (Chinese in the embodiment) is provided in advance and translated into a predetermined translation destination language (English in the embodiment). However, the user may be allowed to specify the translation source language and translation destination language in the same manner as the user language. Thus, when the user is allowed to specify the translation source language and translation destination language, a translation for each candidate character string may be obtained from bilingual dictionaries corresponding to the contents of the selection (i.e., bilingual dictionaries corresponding to the user language specified by the user as well as to the translation source language specified by the user). Moreover, when OCR processing is performed on the original text data transmitted from the image reader, the translation source language may be identified based on the results of the processing.

### C-3: Modification Example 3

The above-described embodiment illustrated a case, in which candidate character strings are selected for word units. However, as shown in FIG. 6, a user may be also allowed to present candidate character strings and select a single candidate character string from among multiple candidate character strings at the level of sentence units, as well as allowed to present candidate character strings and select a single candidate character string at the level of word block units. For example, FIG. 6 shows a case where user language translations for a sentence including the word “****”, for which “mmmm”, “kkkk”, and “pppp” have been identified as candidate character strings, and the user is to select one of the three candidate character strings, are presented. In short, in an embodiment where candidate character strings are presented for the structural units of a text, the structural units may be words, blocks of words or sentences.

### C-4: Modification Example 4

The above-described embodiment illustrated a case, in which a user is allowed to select a single candidate character string from among multiple candidate character strings by presenting user language translations for each candidate character string in case of words having multiple identified candidate character strings. However, when multiple candidate character strings are identified, data representing a specific degree of certainty in terms of OCR processing (for instance, data representing the value of the degree of certainty and priority corresponding to the degree of certainty) can be presented in addition to the translations of the candidate character strings.

### C-5: Modification Example 5

The above-described embodiment illustrated a case, in which the user is assisted in selecting a single candidate character string from among multiple candidate character strings with the help of the display unit 220 displaying user language translations for each candidate character string in case of words having multiple identified candidate character strings. However, the embodiment involving the presentation of user language translations of multiple candidate character strings is not limited to embodiments, where the translations are displayed on the display unit 220. For instance, as shown in FIG. 7, along with outputting the processing results of character recognition processing by printing them on a recording material such as printing paper, in case of words having multiple identified candidate character strings (the word “****” in FIG. 7), it is also possible to print them by adding predetermined checkmarks (“⋄” in FIG. 7) to the user language translations of the candidate character strings. After selecting a single candidate character string from among the multiple candidate character strings by painting out the checkmark provided next to one candidate character string, the user who has visually inspected the thus printed character recognition results can then convey the selection results to the electronic device by letting the image reader 120 read in the printed results once again.

### C-6: Modification Example 6

The above-described embodiment illustrated a case, in which software allowing the control unit 200 to implement the functionality peculiar to the inventive translation apparatus was stored in the non-volatile memory unit 240b in advance. However, it is, of course, possible to put the software on a computer-readable recording medium, such as, for instance, a CD-ROM (Compact Disk Read-Only Memory) or a DVD (Digital Versatile Disk), and install the software on an ordinary computer apparatus using such a recording medium. Doing so achieves the effect of enabling an ordinary computer apparatus to function as the inventive translation apparatus.

As described above, the present invention provides, in one aspect, an electronic device having: an input unit that inputs image data representing a text written in a first language, an identification unit that performs character recognition processing on the image data inputted by the input unit and identifies candidate character strings representing results of the character recognition processing for each of structural units of the text represented by the image data, a specification unit that allows a user to specify a second language, a decision unit that decides whether or not the second language is different from the first language, a presentation unit that presents translations of the candidate character strings in the second language for each of structural units for which plural candidate character strings are identified by the identification unit, when the decision unit decides that the first language and the second language are different, and a selection unit that allows the user to select a single translation from the translations presented by the presentation unit.

With such an electronic device, when the user language specified as the second language by the user is different from the first language, the device presents user language translations of the structural units having multiple identified candidate character strings. Therefore, the user, albeit not skilled in the first language, can select a single candidate character string from the multiple candidate character strings by referring to the translations presented by the presentation unit.

In an embodiment of the aspect, the electronic device may have a generation unit that generates image data or code data representing a text composed using candidate character strings each of which is uniquely identified by the identification unit for a structural unit of the text represented by the image data and using candidate character strings each of which is selected by the selection unit for a structural unit of the text represented by the image data for which plural candidate character strings are identified.

In another embodiment of the aspect, the structural units may be at least one of a word, a block of words or a sentence. In such an embodiment, translations in the second language are presented for words, blocks of words or sentences containing characters with multiple identified candidate character strings, and, as a result, it becomes possible to select a single candidate character string from among the multiple candidate character strings by considering the context and appropriateness in the word, word block or sentence unit, as opposed to cases, where multiple candidate character strings are presented for separate characters.

In another embodiment of the aspect, the presentation unit may present data representing a degree of certainty of the identification made by the identification unit along with a translation in the second language for each of the plural candidate character strings. In such an embodiment, it becomes possible to select a single candidate character string from the multiple candidate character strings by accounting for the degree of certainty in addition to the translations. Moreover, when the structural units are word units, one may determine whether or not the translations of the multiple candidate character strings in the second language are stored in a term dictionary database of the second language (for example, database in which data representing semantic content and usage are stored in association with words in the second language) and direct the presentation unit to present them by raising the priority for the translations stored in the term dictionary database.

In another embodiment of the aspect, the electronic device may further have a translation unit that translates the text represented by the image data or the code data generated by the generation unit to a third language that is different from the first language and from the second language. In such an embodiment, even when the user who uses the electronic device is skilled neither in the first language, i.e. the translation source language, nor in the third language, i.e. the translation destination language, it becomes possible to efficiently correct recognition errors in character recognition results obtained by performing OCR processing on image data representing an original text written in the first language and obtain translations into the third language by subjecting the corrected recognition results to machine translation.

The present invention provides, in another aspect, a computer readable recording medium recording a program for causing a computer to execute functions of the above-described electronic device. In such an embodiment, installing the program recorded in the medium on an ordinary computer apparatus and executing the program makes it possible to impart the same functionality to the computer apparatus as that of the above-described electronic device.

The present invention provides, in another aspect, a method having steps for performing functions of the above-described electronic device.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-090199 filed on Mar. 25, 2005 including specification, claims, drawings and abstract is incorporated herein by reference in its entirety.

What is claimed is:

1. An electronic device comprising:
an input unit that inputs image data representing a text written in a first language,
an identification unit that performs character recognition processing on the image data inputted by the input unit and identifies candidate character strings representing results of the character recognition processing for each of structural units of the text represented by the image data,
a specification unit that allows a user to specify a second language,
a decision unit that decides whether or not the second language is different from the first language,
a presentation unit that presents translations of the candidate character strings in the second language for each of structural units for which a plurality of candidate character strings are identified by the identification means, when the decision unit decides that the first language and the second language are different, and
a selection unit that allows the user to select a single translation from the translations presented by the presentation unit.

2. The electronic device according to claim 1, further comprising a generation unit that generates image data or code data representing a text composed using candidate character strings each of 25 which is uniquely identified by the identification unit for a structural unit of the text represented by the image data and using candidate character strings each of which is selected by the selection unit for a structural unit of the text represented by the image data for which a plurality of candidate character strings are identified.

3. The electronic device according to claim 1, wherein:
the structural units is at least one of a word, a block of words, or a sentence.

4. The electronic device according to claim 1, wherein:
the presentation unit presents data representing a degree of certainty of the identification made by the identification unit along with a translation in the second language for each of the plurality of candidate character strings.

5. The electronic device according to claim 2, further comprising a translation unit that translates the text represented by the image data or the code data generated by the generation means to a third language that is different from the first language and from the second language.

6. A computer readable recording medium recording a program for causing a computer to execute:
receiving image data representing a text written in a first language,
performing character recognition processing on the image data and identifying candidate character strings representing results of the character recognition processing for each of structural units of the text,
allowing a user to specify a second language,
deciding whether or not the second language is different from the first language, and
presenting translations of the candidate character strings in the second language for each of structural units for which a plurality of candidate character strings are identified when it is decided that the first language and the second language are different, and allowing the user to select a single translation from the translations.

7. The computer readable recording medium according to claim 6, wherein the program further causes the computer to execute:
generating image data or code data representing a text composed using candidate character strings each of which is uniquely identified for a structural unit of the text represented by the image data and using candidate character strings each of which is selected for a structural unit of the text represented by the image data for which a plurality of candidate character strings are identified.

8. The computer readable recording medium according to claim 6, wherein:
the structural units is at least one of a word, a block of words, or a sentence.

9. The computer readable recording medium according to claim 6, wherein the program causes the computer to execute, in the process for presenting translations, presenting data representing a degree of certainty of the identification along with a translation in the second language for each of the plurality of candidate character strings.

10. The computer readable recording medium according to claim 7, wherein the program further causes the computer to execute:
translating the text represented by the image data or the code data to a third language that is different from the first language and from the second language.

11. A method comprising:
receiving image data representing a text written in a first language,
performing character recognition processing on the image data and identifying candidate character strings representing results of the character recognition processing for each of structural units of the text,
allowing a user to specify a second language,
deciding whether or not the second language is different from the first language, and
presenting translations of the candidate character strings in the second language for each of structural units for which a plurality of candidate character strings are identified when it is decided that the first language and the second language are different, and allowing the user to select a single translation from the translations.

12. The method according to claim 11, further comprising:
generating image data or code data representing a text composed using candidate character strings each of which is uniquely identified for a structural unit of the text represented by the image data and using candidate character strings each of which is selected for a structural unit of the text represented by the image data for which a plurality of candidate character strings are identified.

13. The method according to claim 11, wherein:
the structural units is at least one of a word, a block of words, or a 25 sentence.

14. The method according to claim 11, wherein, the step for presenting translations comprises presenting data representing a degree of certainty of the identification along with a translation in the second language for each of the plurality of candidate character strings.

15. The method according to claim 12, further comprising:
translating the text represented by the image data or the code data to a third language that is different from the first language and from the second language.
